(19) United States
(12) Patent Application Publication
(10) Pub. No.: US 2014/0337735 A1
(43) Pub. Date: Nov. 13, 2014

(54) METHOD AND APPARATUS FOR GENERATING AND PROVIDING A SHORTCUT

(71) Applicant: Western Digital Technologies, Inc., Irvine, CA (US)

(72) Inventor: JEFFREY YEN-LIANG CHEN, IRVINE, CA (US)

(21) Appl. No.: 13/918,887

(22) Filed: Jun. 14, 2013

Related U.S. Application Data
(60) Provisional application No. 61/821,117, filed on May 8, 2013.

(51) Int. Cl. G06F 3/0481

(52) U.S. Cl. CPC G06F 3/0481
USPC 715/719

(57) ABSTRACT

A media player appliance including a video output configured to connect to a display unit, and a controller configured to access a selected folder. The controller is further configured to receive one or more display preference settings for the selected folder, receive a request to generate a shortcut for the selected folder; generate the shortcut for the selected folder based on the one or more display preference settings in response to receiving the request to generate the shortcut for the selected folder, and provide the shortcut on the display unit using the video output.

### CROSS-REFERENCE TO RELATED APPLICATIONS

This application claims the benefit of U.S. Provisional Application No. 61/821,117, filed on May 8, 2013, entitled “FOLDER SHORTCUT FOR A STORAGE SYSTEM,” which is hereby incorporated by reference in its entirety.

### BACKGROUND

In a conventional media player appliance, shortcuts to various folders are displayed on a display screen. When a user accesses a shortcut, a corresponding content of the folder is displayed on the display screen. Given the boom in digital video and music, the folder may contain a large number of content. However, the user may not wish to access all of the content at once, but instead may wish to access a specific content in the folder. This may be problematic if the folder contains a large number of content. In such a case, the user may be unable to easily locate the specific content in the folder.

### BRIEF DESCRIPTION OF THE DRAWINGS

The features and advantages of the present embodiments will become more apparent from the detailed description set forth below when taken in conjunction with the drawings, wherein:

FIG. 1 depicts a media player appliance, a remote control device, a display unit, and a plurality of content providers according to an embodiment;

FIG. 2 depicts contents of memory in a media player appliance according to an embodiment;

FIG. 3 depicts a home screen user interface according to an embodiment;

FIG. 4 depicts a shortcut definition according to an embodiment;

FIG. 5 depicts contents of a photo folder according to an embodiment;

FIG. 6 depicts contents of a folder in a photo folder according to an embodiment;

FIG. 7 depicts a home screen user interface according to an embodiment;

FIG. 8 depicts a process for generating and providing a shortcut according to an embodiment;

FIG. 9 depicts additional blocks for a process for generating and providing a shortcut according to an embodiment;

FIG. 10 depicts additional blocks for a process for generating and providing a shortcut according to an embodiment; and

FIG. 11 depicts additional blocks for a process for generating and providing a shortcut according to an embodiment.

### DETAILED DESCRIPTION

In an embodiment, a media player appliance 102 is configured to be connected to a display unit 104 and a remote control device 110. In an embodiment the media player appliance 102 comprises a streaming media player, a cable box, a network access storage (“NAS”) device, a direct access storage (“DAS”) device, or other electronic device which may store and play content. Furthermore, the media player appliance 102 can, for example, receive content from one or more content providers 108. In an embodiment, the content providers comprise a NAS device, a DAS device, a streaming media device, a cable provider, a media player, or any other device which can store and provide content that is accessible to the media player appliance 102.

In an embodiment, the media player appliance 102 can receive inputs from the remote control device 110. Furthermore, in an embodiment, the remote control device 110 may be wirelessly connected to the media player appliance 102. However, in an embodiment, the remote control device 110 may also be connected to the media player appliance 102 through a cable. In an embodiment, the media player appliance 102 comprises the remote control device 110.

In an embodiment, the remote control device 110 comprises a limited-input control device. For example, the remote control device 110 may not comprise a separate button for each of the letters of the alphabet and may require for example one or more depressions of a button within a predetermined period of time to provide an input for a letter of the alphabet. In an embodiment, the limited-input control device lacks a QWERTY keyboard. In an embodiment, the remote control device 110 comprises a mobile device comprising an application installed on the mobile device, which allows the mobile device to provide inputs to the media player appliance 102.

In an embodiment, the media player appliance 102 comprises a communications interface 112, a controller 114, memory 116, and a video output 118. In an embodiment, the communications interface 112 is configured to communicate with the content provider 108 directly or through another device. For example, the communications interface 112 can communicate with the content provider 108b directly, such as when the content provider 108b is plugged into the media player appliance 102.

In addition, the communications interface 112 can communicate with the content provider 108a indirectly, such as when the content provider 108a is connected to a network 106. The network 106 can comprise, for example, a local area network (“LAN”), a wide area network (“WAN”), wireless networks, cellular networks, the Internet, a cable network, or other types of networks which can provide access to the content providers 108. In such a case, the communications interface 112 can connect to the network 106 to communicate with the content provider 108a.

In an embodiment, the communications interface 112 allows for the media player appliance 102 to access the one or more content providers 108. In an embodiment, the communications interface 112 is also configured to receive input from the remote control device 110. In an embodiment, the communications interface 112 comprises a network interface controller, Wi-Fi interface, a universal serial bus (“USB”) port, a coaxial cable port, or other ports which may allow the media player appliance 102 to access the one or more content providers 108.

In an embodiment, the video output 118 is configured to connect to the display unit 104 and provide images or video to the display unit 104 so that the video or images can be displayed on the display unit 104. In an embodiment, the display unit 104 comprises a television, a monitor, or other device which may display the content stored and played by the media player appliance 102.

In an embodiment, the memory 116 comprises at least one of a solid state memory or a magnetic rotating disk. Furthermore, the memory 116 comprises a volatile or a non-volatile memory. In an embodiment, the memory 116 is configured to store data on the media player appliance 102.

While the description herein refers to solid state memory generally, it is understood that solid state memory may comprise one or more of various types of solid state non-volatile memory devices such as flash integrated circuits, Chalcogenide RAM (C-RAM), Phase Change Memory (PC-RAM or PRAM), Programmable Metallization Cell RAM (PMC-RAM or PMCm), Ovonic Unified Memory (OUM), Resistance RAM (RRAM), NAND memory (e.g., single-level cell (SLC) memory, multi-level cell (MLC) memory, or any combination thereof), NOR memory, EEPROM, Ferroelectric Memory (FeRAM), Magnetoresistive RAM (MRAM), other discrete NVM (non-volatile memory) chips, or any combination thereof.

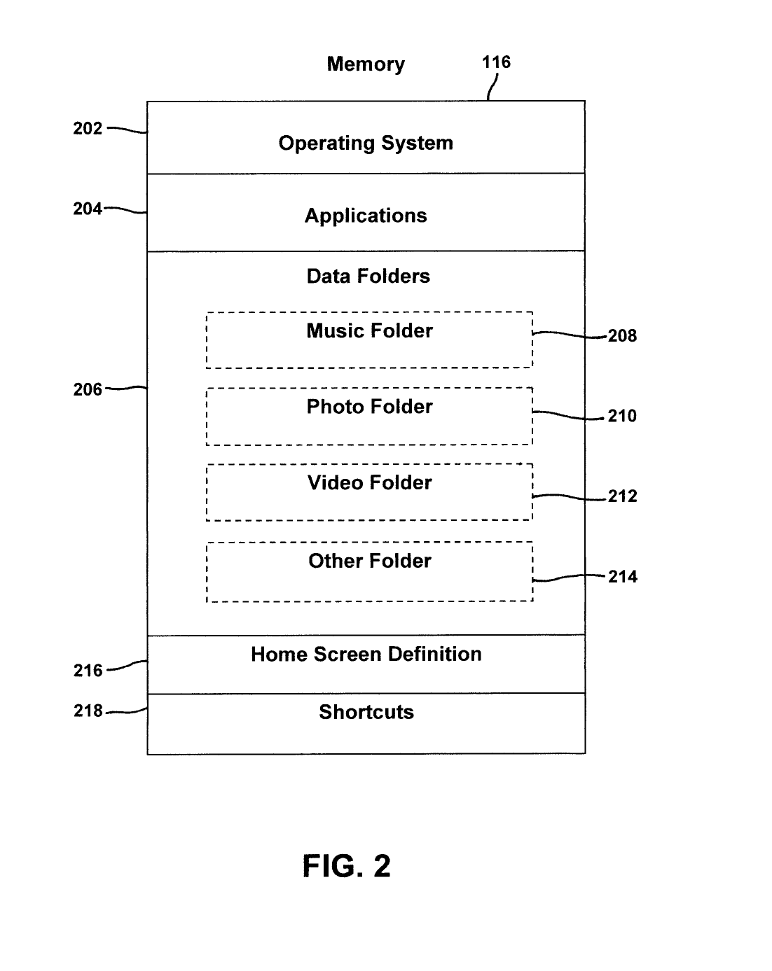

In the embodiment shown in FIG. 2, some of the data stored in the memory 116 are shown. For example, the memory 116 can store an operating system 202, applications 204, data folders 206, a home screen definition 216, and shortcuts 218. In an embodiment, the operating system 202 comprises procedures for handling various basic system services and for performing hardware dependent tasks. In an embodiment, the applications 204 can be executed by a processor in the media player appliance 102 to cause the media player appliance 102 to perform certain operations. In an embodiment, the applications 204 comprise, for example, applications for media playing, TV channels, websites, games, e-mail, widgets, and/or search widgets.

In the embodiment shown in FIG. 2, the data folders 206 comprise a music folder 208, a photo folder 210, a video folder 212, and other folders 214. The music folder 208 comprises, for example, content such as music files. The photo folder 210 comprises, for example, content such as photo files. The video folder 212 comprises, for example, content such as video files. The other folders 214 comprises, for example, other content which may be displayed on the display unit 104, such as e-mail files, word processing documents, text files, or other types of files.

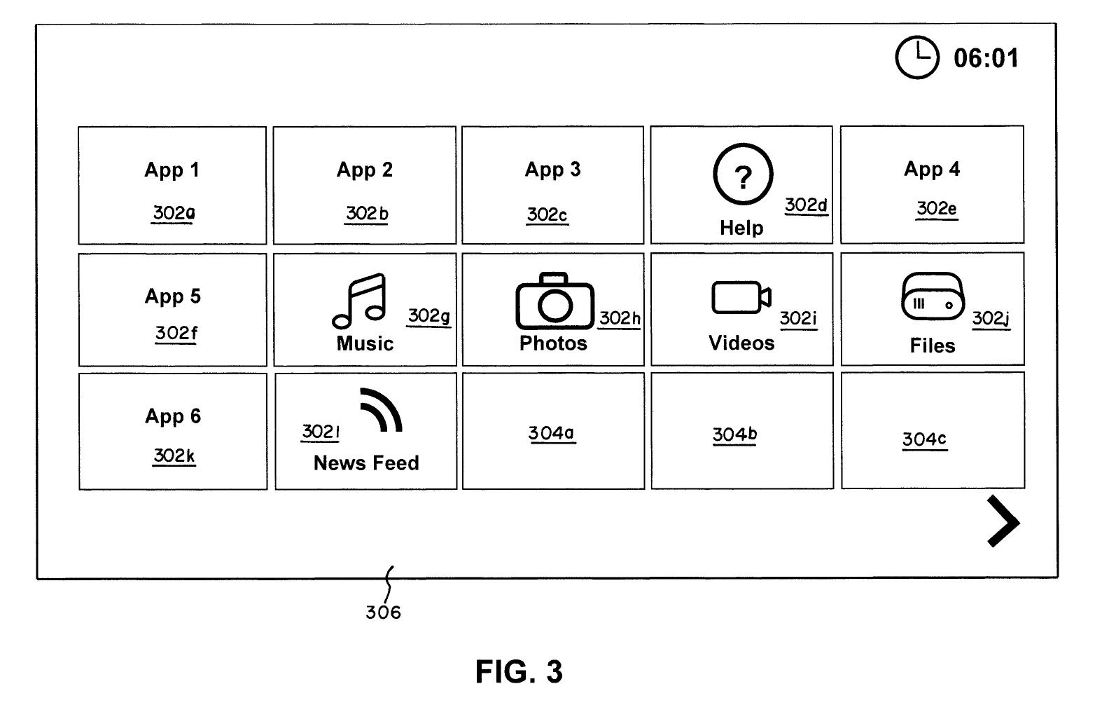

In an embodiment, the home screen definition 216 comprises information for displaying a home screen user interface 306 as shown in the embodiment in FIG. 3. As can be seen in the embodiment shown in FIG. 3, the home screen user interface 306 display the shortcuts 218 as shortcut tiles 302a-302l. Each of the shortcut tiles 302a-302l correspond to a shortcut 218 stored in the memory 116. In an embodiment, the shortcuts 218 corresponding to the shortcut tiles 302a-302l are shortcuts for the applications 204, or one or more folders in the data folders 206. Although the applications 204 and the data folders 206 are shown as being stored in the memory 116, the applications 204 or the data folders 206 can be stored externally from the media player appliance 102. For example, the applications 204 or the data folders 206 can be stored in one or more of the content providers 108 which are accessible by the media player appliance 102.

Furthermore, the home screen user interface 306 comprises tiles 304a-304c, which are open tiles. The tiles 304a-304c indicate that no shortcut 218 has been utilized for that particular tile. However, when a shortcut 218 is added to the home screen user interface 306, a shortcut tile corresponding to the shortcut 218 can be placed in one of the open tiles 304a-304c.

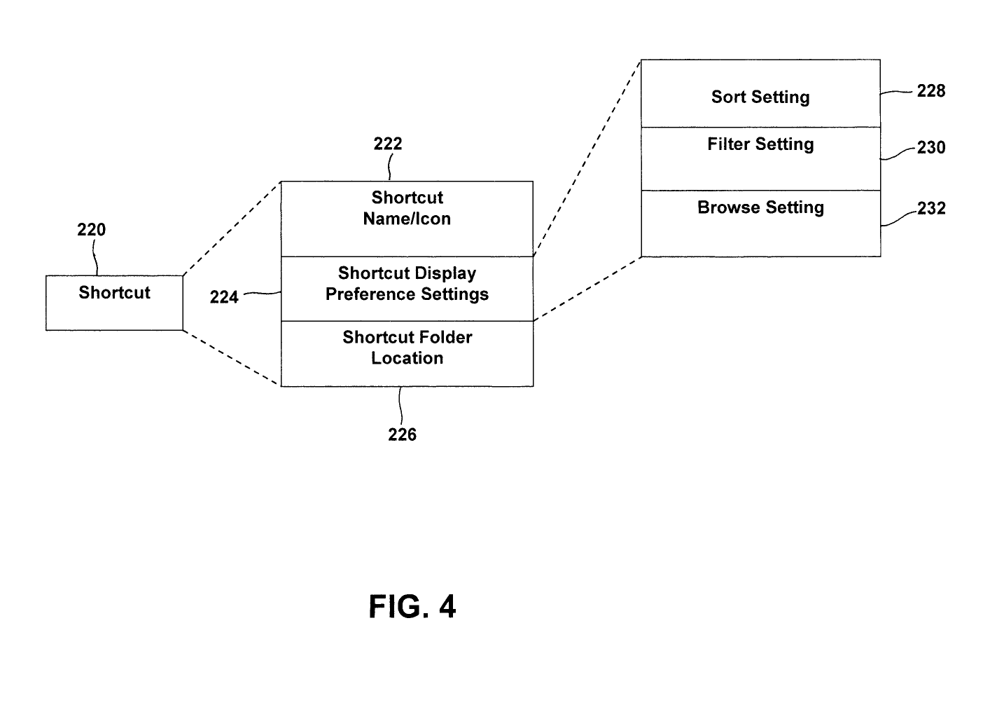

In the embodiment shown in FIG. 4, each of the shortcuts 218 comprises a shortcut definition 220. As can be seen in FIG. 4, each of the shortcut definition 220 comprises a shortcut name/icon information 222, shortcut display preference settings 224, and a shortcut folder location 226. The name/icon information 222 can be utilized to display one or more of the shortcut tiles 302a-302l. For example, with respect to the shortcut tile 302h, a photo icon and the name “Photos” can be displayed using the name/icon information 222. The shortcut folder location 226 indicates the location of the corresponding folder for the shortcut 218. The folder can comprise for example, the location of one or more of the data folders 206.

In an embodiment, the shortcut display preference settings 224 comprises a sort setting 228, a filter setting 230, and/or a browse setting 232 for the contents of the folder corresponding to the shortcut 218. In an embodiment, the browse setting 232 of the contents of the folder may indicate, for example, how the contents of the folder may be viewed during browsing (e.g. browse view). In an embodiment, the contents of the folder may include digital files comprising metadata. The metadata may be used to sort, filter, and/or view the contents of the selected folder.

In an embodiment, with respect to the music folder 208, the contents of the music folder 208 may be sorted by date, alphabetically, ratings, or recently viewed. The contents of the music folder may also be filtered by all albums, all tracks, genre, artist, folders, playlist, untagged (no metadata), new items, queue, or favorites. Furthermore, the contents of the music folder 208 may be browsed by list view or grid view.

In an embodiment, with respect to the photo folder 210, the contents of the photo folder 210 may be sorted by date, alphabetical, ratings, or recently viewed. The contents of the photo folder 210 may also be filtered by all, date (year), date (month), folders, new items, queue, or favorites. Furthermore, the contents of the photo folder 210 may be browsed by list view, small grid view, or large grid view.

In an embodiment, with respect to the video folder 212, the contents of the video folder 212 may be sorted by date, alphabetical, ratings, or recently viewed. The contents of the video folder 212 may also be filtered by all, folders, genre, actor, director, TV show, playlist, untagged (no metadata), new items, movie, queue, or favorites. Furthermore, the contents of the video folder 212 may be browsed by list view, small grid view, large grid view, gallery view, or preview view. The above examples describe just some embodiments of how filtering can be accomplished. In some embodiments, filters described above for one type of folder can be used in another type of folder.

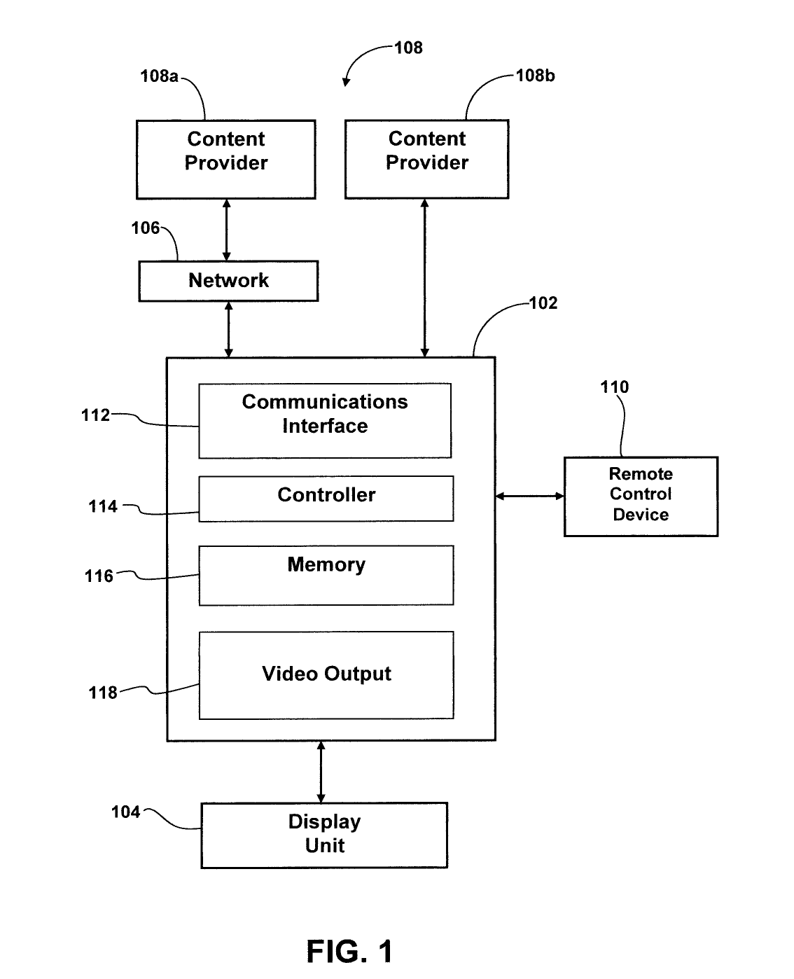

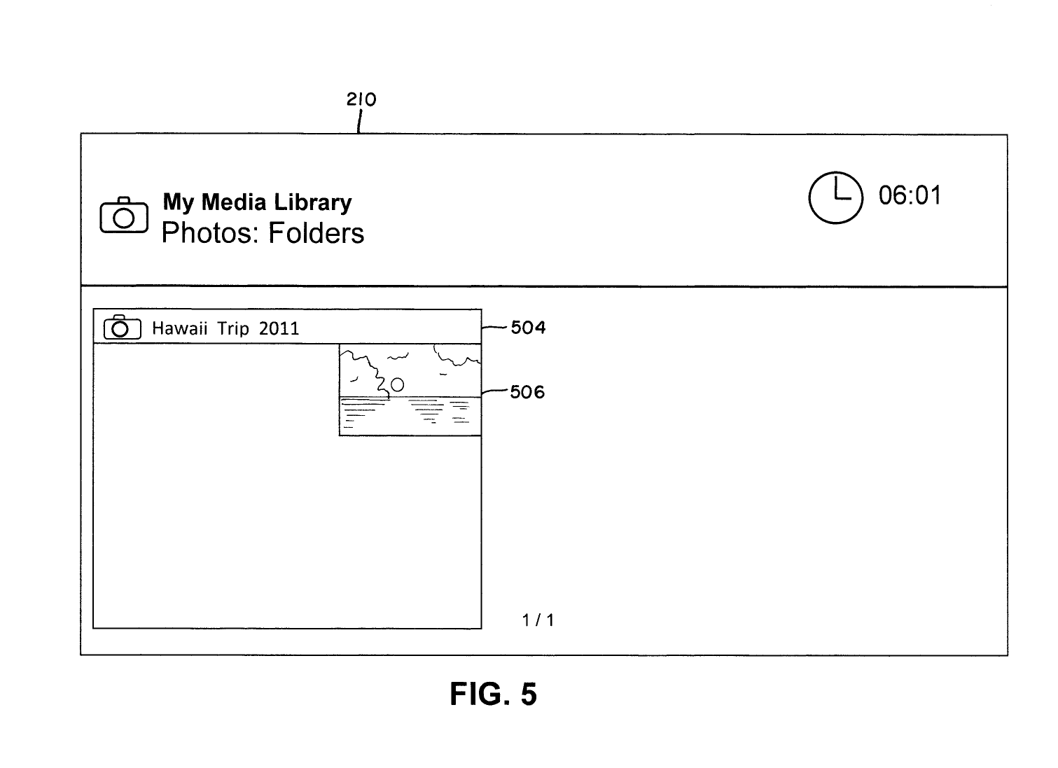

Referring back to the embodiment shown in FIG. 1, in operation, the media player appliance 102 can receive an input from the remote control device 110 indicating that a folder accessible by the media player appliance 102 is selected. For example, as shown in the embodiment in FIG. 3, a folder can be selected by selecting one or more of shortcut tiles 301a-302l corresponding to a shortcut for the folder. Once the folder is selected, the media player appliance 102 can display the contents of the selected folder. For example, as shown in the embodiments in FIGS. 3 and 5, the shortcut tile 302h corresponding to a shortcut for the photo folder 210 can be selected. Thus, as shown in the embodiment in FIG. 5, the contents of the photo folder 210 is displayed. The photo folder 210 includes additional folders such as the folder 504 entitled “Hawaii Trip 2011.” An icon 506 is also displayed for the folder 504. When an input is received by the media player appliance 102 to select the folder 504, the contents of the folder 504 are displayed.

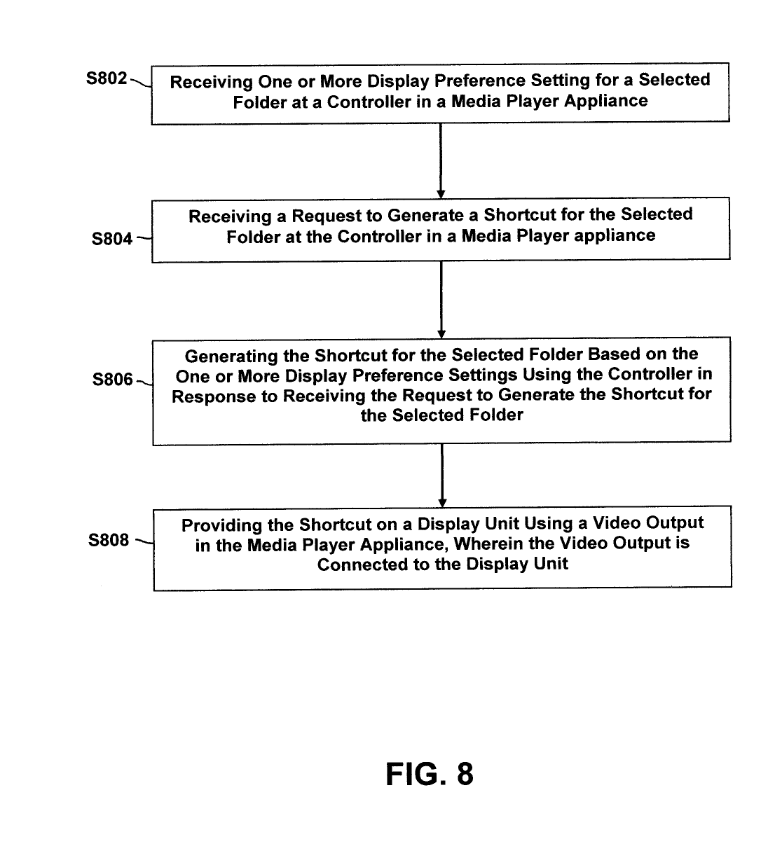

In an embodiment, a shortcut to the folder 504 can be generated based on a process for generating and providing a shortcut as shown in an embodiment in FIG. 8. In block S802, the controller 114 receives one or more display preference settings 224 (FIG. 4). For example, the controller 114 can receive one or more of the sort setting 228, the filter setting 230, or the browse setting 232.

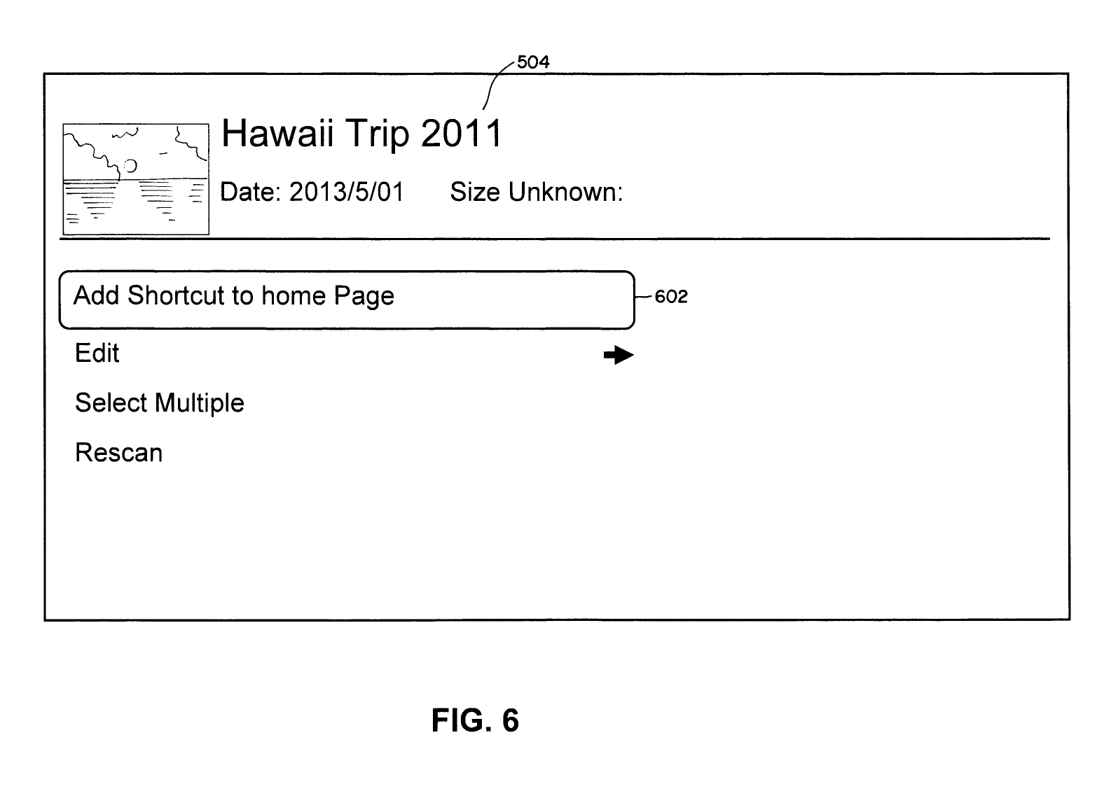

In block S804, the controller 114 receives a request to generate a shortcut for the folder 504. For example, as shown in the embodiment in FIG. 6, the request to generate the shortcut can be transmitted from the remote control device 110 to the media player appliance when a selection 602 for generating the shortcut is detected by the remote control device 110. In block S806, the controller 114 generates the shortcut for the selected folder 504 based on the one or more display preference settings 224 in response to receiving the request to generate the shortcut for the selected folder.

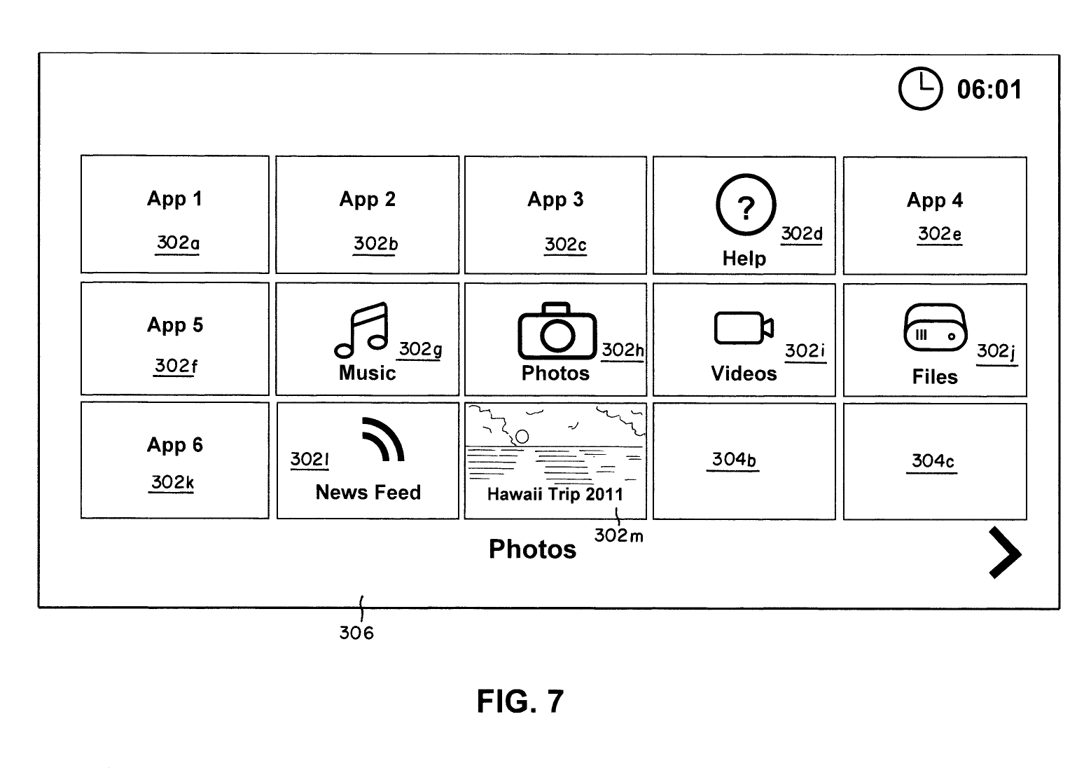

In block S808, the controller 114 provides the shortcut on the display unit 104 using the video output 118. For example, the shortcut tile 302m corresponding to the shortcut for the folder 504 (FIG. 5) can be displayed on the home screen user interface 306 as shown in the embodiment in FIG. 7. In the embodiment shown in FIG. 7, the shortcut tile 302m replaces the tile 304a, which was unused. Furthermore, in the embodiment shown in FIG. 7, the icon 506 (FIG. 5) is utilized for the shortcut tile 302m.

In an embodiment, if a folder accessible by the media player appliance 102 contains an additional folder, the additional folder may be subsequently selected so that the contents of the additional folder may then be displayed on the display unit 104. Similarly, the media player appliance 102 may receive inputs from the user regarding how to sort, filter, and/or view the contents of the selected additional folder via the remote control device 110.

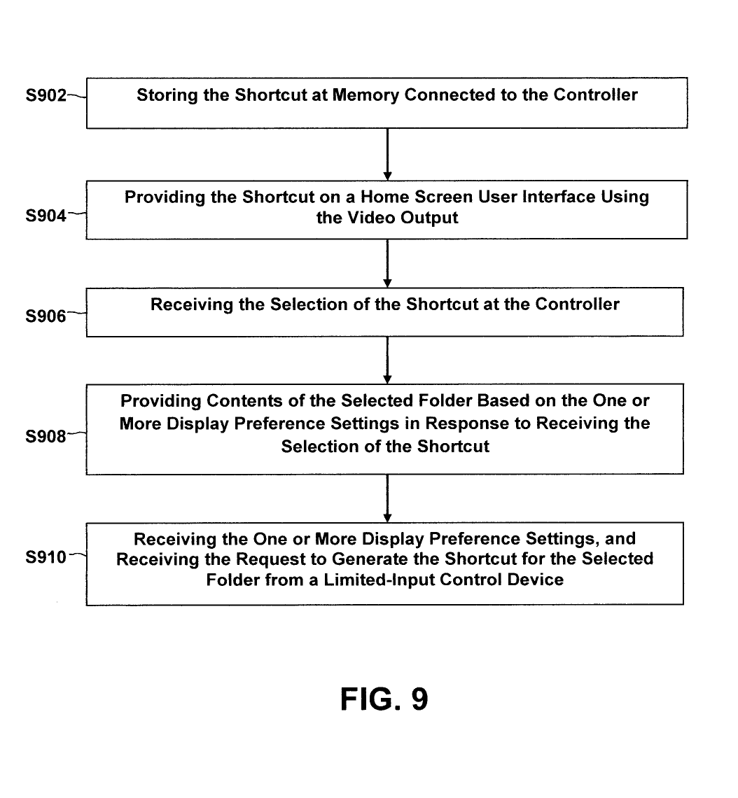

In an embodiment, additional optional blocks for a process for generating and providing a shortcut are shown in an embodiment in FIG. 9. In block S902, the shortcut for the folder 504 is stored in the memory 116. In block S904, the controller 114 provides the shortcut on the home screen user interface using the video output 118. As previously noted, the shortcut tile 302m corresponding to the shortcut for the folder 504 (FIG. 5) can be displayed on the home screen user interface 306 as shown in the embodiment in FIG. 7. In block S906, the controller 114 receives the selection of the shortcut 218 from the remote control device 110. For example, one of the shortcuts corresponding to one of the shortcut tiles 302m (FIG. 7) can be selected using the remote control device 110.

In block S908, the controller 114 provides contents of the selected folder corresponding to the shortcut based on the one or more display preference settings 224 in response to receiving the selection of the shortcut. For example, if the shortcut corresponding to the folder 504 was selected, then the controller 114 will provide the contents of the folder 504 to the video output 118 for display on the display unit 104 based on the display preference settings 224 previously stored. For example, if the sort setting 228 was stored in the memory 116, the contents of the folder 504 will be sorted and displayed based on the sort setting 228. Similarly, if the filter setting 230 was stored in the memory 116, the contents of the folder 504 will be filtered and displayed on the filter setting 230. If the browse setting 232 was stored in the memory 116, the contents of the folder 504 may be browsed based on the brows setting 232 stored in the memory 116. Thus, a user of the media player appliance 102 need not re-input the display preference settings for the folder 504. Instead, the contents of the folder 504 will be displayed based on the previously input display preference settings 224.

In block S910, the controller 114 receives the one or more display preference settings and receives the request to generate the shortcut for the selected folder from a limited-input control device such as the remote control device 110. In the embodiment shown in FIG. 7, the shortcut tile 302m corresponds to the folder 504 (FIG. 5). Thus, when the shortcut tile 302m is selected, an indication that the shortcut 218 corresponding to the folder 504 is selected is transmitted from the remote control device 110 to the media player appliance 102. The controller 114 will then provide the contents of the folder 504 to the display unit 104 using the video output 118 so that the contents of the folder 504 is displayed on the display unit 104.

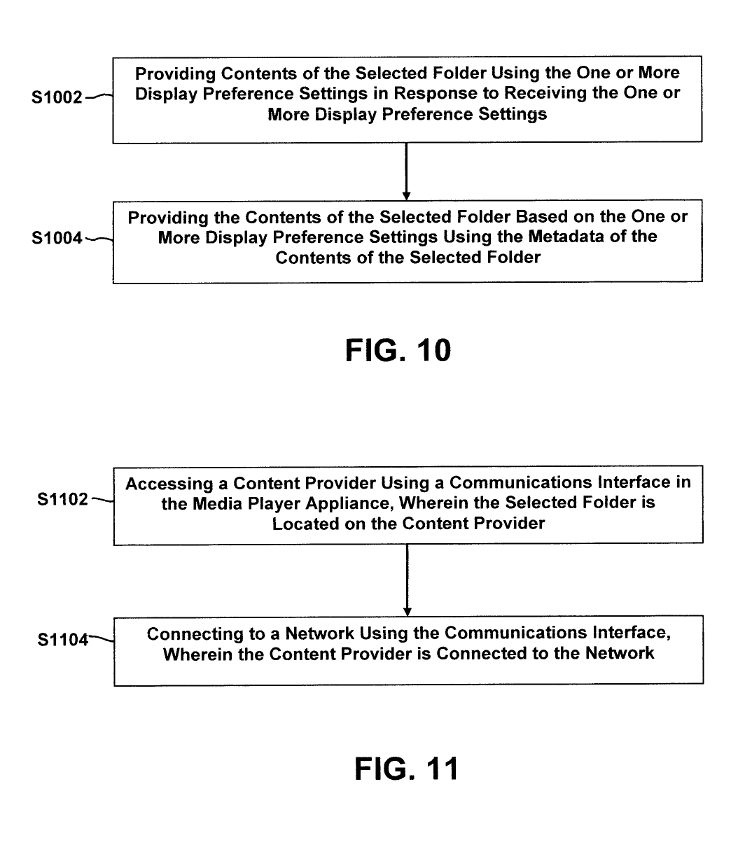

In an embodiment, additional optional blocks for a process for generating and providing a shortcut are shown in an embodiment in FIG. 10. In block S 1002, the controller 114 provides contents of the selected folder using the one or more display preference settings in response to receiving the one or more display preference settings 224 from the remote control device 110. In block S1004, the controller 114 provides the contents of the selected folder based on the one or more display preference settings 224 using the metadata of the contents of the selected folder.

In an embodiment, additional optional blocks for a process for generating and providing a shortcut are shown in an embodiment in FIG. 11. In block S1102, the controller 114 accesses the content provider 108 using the communications interface 112. For example, the controller 114 accesses the content providers 108a and/or 108b using the communications interface 112. In block S1104, the controller 114 connects to the network 106 using the communications interface 112, wherein the content provider 108a is connected to the network 106.

Those of ordinary skill would appreciate that the various illustrative logical blocks, modules, and algorithm parts described in connection with the examples disclosed herein may be implemented as electronic hardware, computer software, or combinations of both. Furthermore, the embodiments can also be embodied on a non-transitory machine readable medium causing a processor or computer to perform or execute certain functions.

To clearly illustrate this interchangeability of hardware and software, various illustrative components, blocks, modules, circuits, and process parts have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed apparatus and methods.

The parts of a method or algorithm described in connection with the examples disclosed herein may be embodied directly in hardware, in a software module executed by a processor, or in a combination of the two. The parts of the method or algorithm may also be performed in an alternate order from those provided in the examples. A software module may reside in RAM memory, flash memory, ROM memory, EPROM memory, EEPROM memory, registers, hard disk, a removable disk, an optical disk, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC).

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the disclosure is, therefore, indicated by the appended claims rather than by the foregoing description. All changes which come within the meaning and range of equivalency of the claims are to be embraced within their scope.

What is claimed is:

1. A media player appliance comprising:
a video output configured to connect to a display unit; and
a controller configured to access a selected folder, the controller further configured to:
receive one or more display preference settings for the selected folder;
receive a request to generate a shortcut for the selected folder;
generate the shortcut for the selected folder based on the one or more display preference settings in response to receiving the request to generate the shortcut for the selected folder; and
provide the shortcut on the display unit using the video output.

2. The media player appliance of claim 1 further comprising memory connected to the controller and configured to store the shortcut.

3. The media player appliance of claim 1 wherein the controller is further configured to provide the shortcut on a home screen user interface using the video output.

4. The media player appliance of claim 1 wherein the controller is further configured to provide contents of the selected folder using the one or more display preference settings in response to receiving the one or more display preference settings.

5. The media player appliance of claim 1 wherein the display preference settings further comprise at least one of a sort setting, a filter setting, or a browse setting.

6. The media player appliance of claim 1 wherein the selected folder comprises at least one of a photo folder, a video folder, or a music folder.

7. The media player appliance of claim 1 wherein the controller is further configured to:
receive a selection of the shortcut; and
provide contents of the selected folder based on the one or more display preference settings in response to receiving the selection of the shortcut.

8. The media player appliance of claim 7 wherein the contents of the selected folder further comprises metadata and the controller is configured to provide the contents of the selected folder based on the one or more display preference settings using the metadata of the contents of the selected folder.

9. The media player appliance of claim 1 further comprising a communications interface configured to be connected to a content provider and provide access to the content provider for the controller, wherein the selected folder is located on the content provider.

10. The media player appliance of claim 9 wherein the communications interface is further configured to be connected to a network, and the content provider is connected to the network.

11. The media player appliance of claim 1 wherein the controller is further configured to receive the one or more display preference settings, and receive the request to generate the shortcut for the selected folder from a limited-input control device.

12. The media player appliance of claim 1 wherein the media player appliance comprises a limited-input control device, and wherein the controller is further configured to receive the one or more display preference settings, and receive the request to generate the shortcut for the selected folder from the limited-input control device.

13. The media player appliance of claim 1 wherein the display unit comprises a television.

14. A method for generating and providing a shortcut comprising:
receiving one or more display preference settings for a selected folder at a controller in a media player appliance;
receiving a request to generate a shortcut for the selected folder at the controller;
generating the shortcut for the selected folder based on the one or more display preference settings using the controller in response to receiving the request to generate the shortcut for the selected folder; and
providing the shortcut on a display unit using a video output in the media player appliance, wherein the video output is connected to the display unit.

15. The method of claim 14 further comprising storing the shortcut at memory connected to the controller.

16. The method of claim 14 further comprising providing the shortcut on a home screen user interface using the video output.

17. The method of claim 14 further comprising providing contents of the selected folder using the one or more display preference settings in response to receiving the one or more display preference settings.

18. The method of claim 14 wherein the display preference settings further comprise at least one of a sort setting, a filter setting, or a browse setting.

19. The method of claim 14 wherein the selected folder comprises at least one of a photo folder, a video folder, or a music folder.

20. The method of claim 14 further comprising:
receiving a selection of the shortcut at the controller; and
providing contents of the selected folder based on the one or more display preference settings in response to receiving the selection of the shortcut.

21. The method of claim 20 wherein the contents of the selected folder further comprises metadata.

22. The method of claim 21 further comprising providing the contents of the selected folder based on the one or more display preference settings using the metadata of the contents of the selected folder.

23. The method of claim 14 further comprising accessing a content provider using a communications interface in the media player appliance, wherein the selected folder is located on the content provider.

24. The method of claim 23 further comprising connecting to a network using the communications interface, wherein the content provider is connected to the network.

25. The method of claim 14 further comprising:
receiving the one or more display preference settings, and receiving the request to generate the shortcut for the selected folder from a limited-input control device.

26. A non-transitory machine-readable medium comprising instructions which when executed by a processor cause a media player appliance to generate and provide a shortcut by at least:
receiving one or more display preference settings for a selected folder at a controller in a media player appliance;
receiving a request to generate a shortcut for the selected folder at the controller;
generating the shortcut for the selected folder based on the one or more display preference settings using the controller in response to receiving the request to generate the shortcut for the selected folder; and
providing the shortcut on a display unit using a video output in the media player appliance, wherein the video output is connected to the display unit.

27. The non-transitory machine-readable medium of claim 26 wherein the instructions further cause the media player appliance to generate and provide the shortcut by at least providing contents of the selected folder using the one or more display preference settings in response to receiving the one or more display preference settings.
